(19) United States
(12) Patent Application Publication
(10) Pub. No.: US 2020/0123929 A1
(43) Pub. Date: Apr. 23, 2020

(54) FAILURE DETECTION SYSTEM OF A COOLING AIR SUPPLY SYSTEM AND A FAILURE DETECTION METHOD FOR A COOLING AIR SUPPLY SYSTEM OF A HIGH-PRESSURE TURBINE

(71) Applicant: Rolls-Royce Deutschland Ltd & Co KG, Blankenfelde-Mahlow (DE)

(72) Inventor: Charilaos KAZAKOS, Berlin (DE)

(21) Appl. No.: 16/582,161

(22) Filed: Sep. 25, 2019

(30) Foreign Application Priority Data
Oct. 17, 2018 (DE) 10 2018 125 748.1

(51) Int. Cl. F01D 25/14; F01D 9/06; F01D 21/00

(52) U.S. Cl. CPC F01D 25/14; F01D 9/06; F01D 21/003; F05D 2260/80; F05D 2240/14; F05D 2260/20; F05D 2220/3212

(57) ABSTRACT

The invention relates to a detection system for a cooling air supply system of a high-pressure turbine of a gas turbine engine, wherein
a first cooling air stream is taken from a first section of a compressor via a piping system,
a second cooling air stream is taken from a second section of the compressor via at least one cavity in the engine,
a mixing section for at least a part of the first and second cooling air stream with a temperature sensor sensing the temperature of the mixture of the first and second cooling air streams in the mixing section. The invention also relates to a method for detecting a failure in the cooling of a high-pressure turbine.

This application claims priority to German Patent Application DE102018125748.1 filed Oct. 17, 2018, the entirety of which is incorporated by reference herein.

The present disclosure relates to a failure detection system of cooling air supply system of a high-pressure turbine with the features of claim 1 and a failure detection method of a cooling air supply system for a high-pressure turbine with the features of claim 9.

In gas turbine engines, such as turbo engines or geared turbofan engines for aircrafts hot gas is directed from a combustion device to drive a high-pressure turbine downstream from the combustion device.

The first stages of the high-pressure turbine (e.g. the nozzle guide vane stator stage 1 (NGV1), the high-pressure turbine rotor stage 1 (HPT R1), and the cavity at the casing radially outside HPR R1 are typically cooled by bleed air from the high-pressure section of a compressor section of the gas turbine engine. This is typically realized via internal cavities which guide the cooling air to the high-pressure turbine.

As the pressure drops in the axial direction of the turbine, the subsequent stages downstream do not require cooling air at such a high-pressure level compared to the first stages. Hence, the nozzle guide vane stator stage 2 (NGV2) and the cavity of the casing radially outside NGV2 are cooled by mid-stage air from the compressor section. This is typically realized via an external piping system which is delivering the cooling air to the required turbine section.

Failures in the cooling air supply system can result in the deterioration of the first stages of the turbine. Therefore, effective systems and methods addressing this issue are required.

According to a first aspect there is provided a detection system of cooling air supply system of a high-pressure turbine of a gas turbine engine.

The cooling air supply system comprises a first and a second cooling air stream. The first cooling air stream is taken from a first section of a compressor of the gas turbine engine via a piping system and the second cooling air stream is taken from a second section of the compressor via at least one cavity in the engine. Therefore, two different air streams are used for cooling purposes. The difference, depending on the origin of the cooling air streams, is in the temperature, the pressure and/or the flowrate. The second cooling air stream can e.g. have a higher flowrate. Flow rates can e.g. be controlled by a pressure ratio of each stream (i.e. the source pressure, which is the given HPC stage, divided by the sink pressure, which can be the ambient (in case the detection system is routed towards the ambient as will be described below)). It is also possible that the cross-sectional area of the channels used to route this air streams is used for the adjustment of the flowrates. Since for a given engine application the pressure ratios for the air streams are given, the size of the channels shall be defined accordingly in order to fulfil the desired flow split between the channels.

Furthermore, the detection system comprises a mixing section for at least a part of the first and second cooling air stream with a temperature sensor sensing the temperature of the mixture of the first and second cooling air streams in the mixing section.

If there is a failure in e.g. the piping system which delivers cooling air to the turbine sections, the flowrate and/or pressure of the part taken from the first cooling air stream will drop significantly. As a consequence, the temperature in the mixing section will change as well because the part taken from the second cooling air stream will dominate in the mixing section due to its higher pressure than part taken from the first air stream. This change is detected by the temperature sensor allowing an efficient detection of the failure. If the temperature of the cooling air streams would be measured individually without mixing, a failure might not be detected efficiently since the flow rate of the cooling air stream might change, but not the temperature. Therefore, the failure detection takes place in the mixing section.

In one embodiment the second cooling air stream is directed towards a first stator stage of the high-pressure turbine, a first rotor stage of the high-pressure turbine and/or the casing radially outward of the a first stator stage of the high-pressure turbine, a first rotor stage of the high-pressure turbine. This is the section of the high-pressure turbine with the highest temperatures, requiring efficient cooling.

In a further embodiment the first cooling air stream is directed towards a casing section, a stator/and or rotor downstream from the first rotor of the high-pressure turbine. This is a cooler section since it is further downstream from the combustion device.

The mixing section can be vented by e.g. routing the mixed air to a lower pressure environment, in particular to the bypass airflow or the ambient.

In one further embodiment, the flow of the second cooling air stream into the mixing section is taken from a location downstream of a sealing device. The sealing device is reducing the pressure of the second stream to a level below the pressure of the other stream. Otherwise, its pressure would always be higher than the other stream and hence the sensor would always read the temperature from this stream only.

Further, it is possible that the first cooling air stream is taken from a mid-pressure section of the compressor and the second cooling air stream is taken from high-pressure section of the compressor. With this arrangement, different temperatures and pressures are present in the streams used in the mixing section.

The temperature sensor can be connected to a control system of the gas turbine engine. The control system is configured to adjust operating conditions of the gas turbine engine in dependence of the temperature measurement by the temperature sensor. One example would be the issuing of a warning signal that the cooling of the high-pressure turbine is not effectively working. Furthermore, the control system might reduce the fuel supply to the combustion device to lower the power output—and thereby the heat generation—of the gas turbine engine.

One way to implement an embodiment of the mixing section is the use of an air pipe in which the parts of the cooling air streams are mixed.

The issue is also addressed by a detection method for a cooling air supply system with the features of claim 9.

The system comprises a first cooling air stream taken from a first section of a compressor via a piping system and a second cooling air stream taken from a second section of a compressor via at least one cavity in the engine. Therefore, the two cooling air streams have different temperatures, pressures and/flowrates.

At least parts of the first and second cooling air streams are mixed in a mixing section and a temperature sensor is sensing the temperature of the mixing temperature of the first and second cooling air streams in the mixing section.

The temperature sensor can transmit the measured temperature data to a control system of the gas turbine engine and the control system then adjusts the operating conditions of the gas turbine engine in dependence of the temperature measurement by the temperature sensor.

The cooling air supply system can be used in a gas turbine engine for an aircraft

Embodiments will now be described by way of example only, with reference to the Figures, in which:

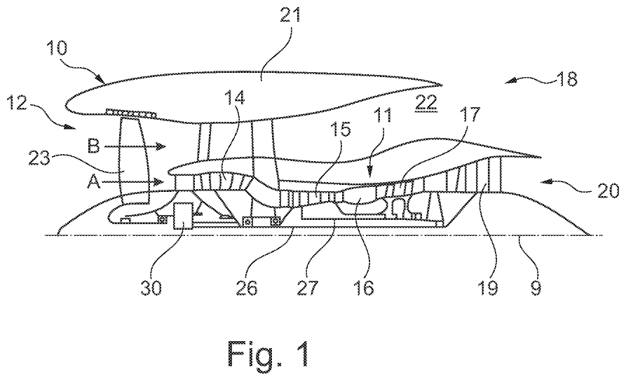

FIG. 1 is a sectional side view of a gas turbine engine;

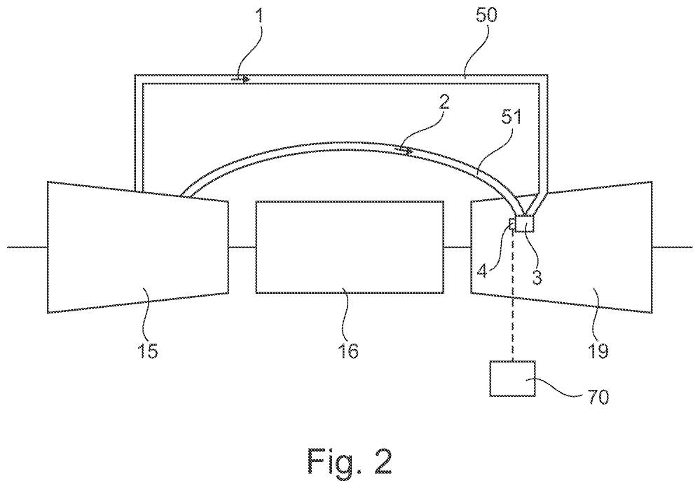

FIG. 2 is schematic view of a compressor section, a combustion and a turbine section indicating cooling air streams;

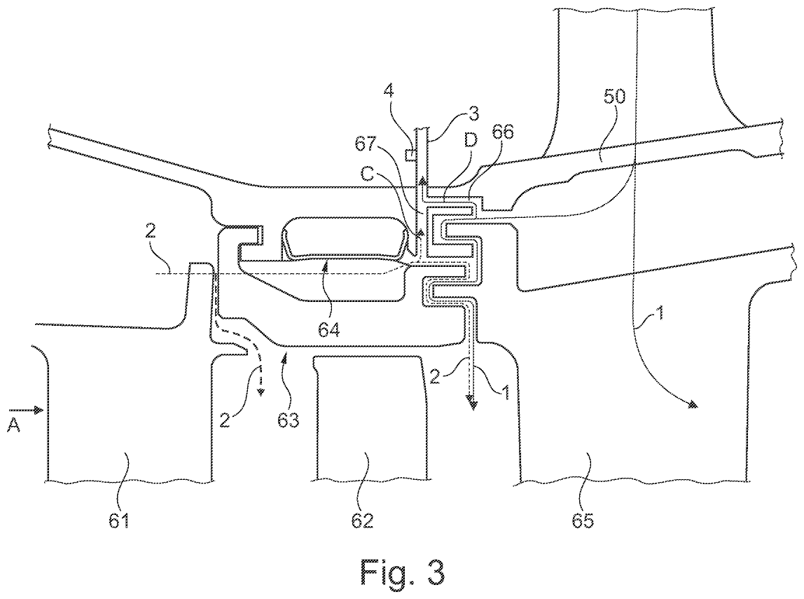

FIG. 3 a sectional view of the casing surrounding the first stages of a high-pressure turbine with cooling air and an embodiment of a failure detection system of a cooling systems.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

For the discussion of embodiments of the cooling air supply systems and the cooling air method, a simplified sectional view of a gas turbine engine 10 is shown in FIG. 2, i.e. between the high-pressure compressor 15 and the high-pressure turbine 17.

In FIG. 2 one embodiment is shown in which a first cooling air stream 1 is taken from a middle-section of the high-pressure compressor 15 via a piping systems 50.

A second cooling air stream 2 taken from the high-pressure section of the high-pressure compressor 15 and is guided via cavities 51 towards its cooling target in the high pressure turbine 17. The cooling targets of the first and second cooling air streams 1, 2 are shown in more detail in FIG. 3.

Parts (see FIG. 3 for parts D, C) of the first and second cooling air streams 1, 2 are mixed in a mixing section 3 (e.g. a pipe for an air flow) which is shown schematically in FIG. 2. This means that the temperature (and the pressure) in the mixing section 3 depends on the flow rates of the first and second cooling air streams 1, 2 and their respective temperature and pressures. A temperature sensor 4 is measuring the temperature in the mixing section 3.

In the following it is described how a measured temperature change can be used to infer information about a potential failure in the cooling air supply system. In the following simplified data is used to illustrate the embodiment. Other embodiments would result in different data.

The part D of the first cooling air stream in a first duct 66 of the mixing section 3 has a flow rate of m₁=0.025 kg/s, a pressure of p₁=1780 kPa (17.8 bar) and a temperature of T₁=480° C.

The part C of the second cooling air stream in the second duct 67 of the mixing section 3 has a flow rate of m₂=0.01 kg/s, a pressure of p₂=1620 kPa (16.2 bar) and a temperature of T₂=580° C.

As will be shown in FIG. 3, the pressure p₂ of the second cooling air flow 2 is smaller than p₁ of the first cooling air flow 1 because the pressure p₁ is taken after a pressure drop over a sealing device 64. The flowrate m₂ of the second cooling air stream 2 is considerably smaller than m₁ of the first cooling air stream 1. Parts D, C of those cooling airflows 1, 2 are taken into the mixing section 3 (see FIG. 3 for an embodiment).

The mixing section 3 is a small pipe section into with the first and second cooling air streams 1, 2 are mixed. The flowrate here is mₘ=0.035 kg/s. The mixing temperature is Tₘ=508° C. This temperature is closer to temperature T₁ of the first cooling air stream 1, than T₂ of the second cooling air stream 2. Due to the flowrates and the temperatures of the cooling air streams 1, 2, the temperature Tₘ in the mixing section is dominated by the properties of the first cooling air stream 1 under nominal engine operating conditions.

Under failure, e.g. a rupture in the piping system 50 for the first cooling air stream 1 the situation in the mixing section 3 will change considerably, since the pressure levels will change. The pressure in the piping system 50 carrying the first cooling air stream 1 will drop significantly. Therefore, the air from the second air cooling stream 2 will dominate the conditions in the mixing section 3. This will result in a temperature increase e.g. in the order of 100 K which is detectable by the temperature sensor 4 coupled to the mixing section 3.

This temperature information is transmitted to a control system 70 (e.g. part of the electronic engine control EEC) which can generate a warning and/or automatically generate steps to mitigate the failure.

In FIG. 3 a sectional view of a part of the entrance region of the high-pressure turbine 17 is shown. The core airflow A is entering the high-pressure turbine 17 and passes the first stator stage 61 (nozzle guide vane) of the high-pressure turbine 17. Downstream are the first rotor stage 62 and the second stator stage 65. The core airflow A is radially constrained by the casing 63 radially outward from the first stage stator and rotor 61, 62.

In particular the casing 63, the stators 61, 65 and the rotor 62 require some dedicated cooling.

The upstream engine parts, in particular the nozzle guide vane 61, are cooled by the second cooling air stream 2 which is guided through cavities (not shown here) towards the high-pressure turbine 17. The second cooling air stream 2 is taken from the high-pressure section of the high-pressure compressor 15.

As can be seen in FIG. 3, the second cooling air stream 2 has different entry points into the core airflow A. The one behind the first rotor stage 62 is shared with the first cooling air stream 1. Before the mixing of the streams 1, 2 the pressure of the second cooling air stream 2 is reduced by a sealing device 64 to the p₂.

The engine parts further downstream are cooled in particular by the first cooling air stream 1 taken from the mid-pressure section of the high-pressure compressor 15 via a piping system 51 (only partially shown in FIG. 3). One part of the first cooling air stream 1 is guided to the labyrinth sealing and mixed with the first cooling air stream 1. A second part is guided past the second stator stage 65.

Before the mixing of the cooling air streams 1, 2 a first duct 66 takes a part D of the first cooling air flow 1 to the mixing section 3. A second duct 67 takes a part C of the second cooling air flow 2 to the mixing section 3. In the mixing section 3, the mixing of the parts C, D of the cooling air streams 1, 2 takes place as described above. The flows D, C are respectively taken from the first and second cooling air streams 1, 2.

In case the piping system 50 is damaged somehow, the temperature sensor 4 reads a drastic temperature change, i.e. an increase in the case the part D taken from the first cooling air flow (the flow in the first duct 66) dominates the conditions in the mixing section 3. Therefore, the mixing section 3 and the temperature sensor 4 are means to enable a temperature change measurement under a failure regime.

The present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### LIST OF REFERENCE NUMBERS

1 first cooling air stream
2 second cooling air stream
3 mixing section for first and second cooling air stream
4 temperature sensor
9 principal rotational axis
10 gas turbine engine
11 engine core
12 air intake
14 low-pressure compressor
15 high-pressure compressor
16 combustion equipment
17 high-pressure turbine
18 bypass exhaust nozzle
19 low-pressure turbine
20 core exhaust nozzle
21 nacelle
22 bypass duct
23 propulsive fan
24 stationary support structure
26 shaft
27 interconnecting shaft
28 sun gear
30 gearbox
32 planet gears
34 planet carrier
36 linkages
38 ring gear
40 linkages
50 piping system for first cooling air stream
51 cavity for second cooling air supply system
61 first stator stage of high-pressure turbine (nozzle guide vane)
62 first rotor stage of high-pressure turbine
63 casing radially outward from first stage stator and/or rotor
64 sealing device
65 second stator stage of high-pressure turbine
66 first duct
67 second duct
70 control system
A core airflow
B bypass airflow
C part of second cooling air stream flowing into mixing section
D part of first cooling air stream flowing into mixing section

1. A detection system of a cooling air supply system of a high-pressure turbine of a gas turbine engine, wherein
a first cooling air stream is taken from a first section of a compressor via a piping system,
a second cooling air stream is taken from a second section of the compressor via at least one cavity in the engine,
a mixing section for at least a part of the first and second cooling air stream with a temperature sensor sensing the temperature of the mixture of the first and second cooling air streams in the mixing section.

2. The detection system of a cooling air supply system according to claim 1, wherein the second cooling air stream is directed towards a first stator stage of the high-pressure turbine, a first rotor stage of the high-pressure turbine and/or a casing radially outward of the a first stator stage of the high-pressure turbine, a first rotor stage of the high-pressure turbine.

3. The detection system of a cooling air supply system according to claim 1, wherein the first cooling air stream is directed towards a casing section, a stator/and or rotor downstream from the first rotor of the high-pressure turbine.

4. The detection system of a cooling air supply system according to claim 1, wherein the mixed air in the mixing section is routed to a lower pressure environment, in particular to the bypass airflow and/or the ambient.

5. The detection system of a cooling air supply system according to claim 1, wherein the flow of the second cooling air stream into the mixing section is taken from a location downstream of a sealing device.

6. The detection system of a cooling air supply system according to claim 1, wherein the first cooling air stream is taken from a mid-pressure section of the compressor and the second cooling air stream is taken from high-pressure section of the compressor.

7. The detection system of a cooling air supply system according to claim 1, wherein the temperature sensor is connected to a control system of the gas turbine engine and the control system is configured to adjust operating conditions of the gas turbine engine in dependence of the temperature measurement by the temperature sensor.

8. The detection system of a cooling air supply system according to claim 1, wherein the mixing section comprises an air pipe.

9. A detection method of a cooling air supply system for a high pressure turbine of an gas turbine engine, wherein
a first cooling air stream is taken from a first section of a compressor via a piping system,
a second cooling air stream is taken from a second section of the compressor via at least one cavity in the engine,
the first and second cooling air streams are mixed in a mixing section and a temperature sensor is sensing the temperature of the mixing temperature of at least parts of the first and second cooling air streams in the mixing section.

10. The detection method of a cooling air supply system according to claim 9, wherein the temperature sensor sends temperature data to a control system of the gas turbine engine and the control system adjusts operating conditions of the gas turbine engine in dependence of the temperature measurement by the temperature sensor.

11. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft, with a detection system of an air supply system according to claim 1.
